(19) United States
(12) Patent Application Publication
(10) Pub. No.: US 2010/0180781 A1
(43) Pub. Date: Jul. 22, 2010

(54) Apparatus and Method For Embossing Braille Types Onto Laminar Elements

(75) Inventor: Franco Foppapedretti, Caravaggio (BG) (IT)

Correspondence Address: HESS PATENT LAW FIRM, P.C., 9 MIRAMAR LANE, STAMFORD, CT, 06902, US

(73) Assignee: PRO FORM S.R.L., Caravaggio (BG) (IT)

(21) Appl. No.: 12/670,031

(22) PCT Filed: Jul. 27, 2007
(86) PCT No.: PCT/IT07/00539

§ 371 Date: Mar. 25, 2010

(51) Int. Cl. B31F 1/07

(52) U.S. Cl. 101/28; 101/32

(57) ABSTRACT

The present invention relates to an apparatus and a method for embossing raised dots (B) on plate elements (A), at least partly plastically deformable. The apparatus comprises at least one punch (31) movable alternatively along a first direction (Z) to emboss a raised dot (B), on a plate element (A) which rests, on a work surface intercepted by said first, direction (Z). Advantageously, the apparatus also comprises a feed device (2) of the plate element (A) along a second direction (X), which can be operated to feed new sections of said plate element (A) to the punch (31). The punch (31) can be translated along a third direction (Y), orthogonal to said first direction (Z), to emboss at least another raised dot (B) along a same section of the plate element (A).

### FIELD OF THE INVENTION

The present invention relates to an apparatus and a method for embossing raised dots on plate elements, in particular for embossing Braille characters on metal plates.

### STATE OF THE ART

Recently, in order to protect blind or visually impaired people, in many countries it has been made mandatory to provide raised writing, which can be read through touch and describing the product marketed, on the packaging of various consumer goods. In general the raised writing is made with characters from the Braille alphabet. As is known, Braille writing is based on a combination of dots raised with respect to a backing and which are read by moving the fingertips over the dots. For example, European Directive no. 2001/83/EC provides that all packaging of medicinal products marketed must be provided with Braille writing, which can be read by the blind. This writing must correspond to precise international standards. In other words, the height and diameter of the raised dots and the curvature of the tip are subject to standards.

The German utility model DE 202005020833U describes a packaging for consumer goods of various nature, provided with Braille characters for the blind. The raised dots are produced on the paper or cardboard of the packaging, facing the outside so as to be easily felt by users.

One of the most widely used systems for producing Braille writing on paper media involves silk-screen printing of the raised dots. The dots are obtained by depositing on the paper medium a thick layer of ink which is subsequently hardened by drying, for example using UV rays.

Examples of processes for silk-screen printing of Braille characters on paper media are provided in the Italian patent application ITGE940089A and in the international patent application WO 87/07221. Systems based on silk-screen printing have proved to be costly. Moreover, these systems do not allow Braille characters to be printed easily on metal media.

In alternative to silk-screen printing, one of the most widely used systems is embossing of the raised dots on the relative media. In general, the term embossing is intended as a mechanical process to stamp yielding materials, such as leather, fabric, paper, plastic, metal, etc.

The Japanese patent application JP 2006235264 describes an apparatus for embossing raised dots on paper web media. The apparatus comprises a printing cylinder, on the surface of which there are raised Braille characters with the writing to be produced on the media, and a counter cylinder positioned to press against the printing cylinder. The web media, for example a paper or cardboard web is fed pressed inbetween the two cylinders made to rotate in opposite directions. The printing cylinder stamps the Braille characters on the web media. In practice, the dots projecting from the surface of the printing cylinder perform embossing of the web media, producing corresponding raised dots on the surface thereof. The counter cylinder is covered with an elastomer that deforms so that it does not obstruct forming of the raised dots on the web media.

An apparatus has recently become available on the market which performs embossing directly on the blanks to be used to form the packaging of pharmaceutical products. The blanks, not yet in the upright configuration, are fed between an embossing cylinder on the surface of which are protrusions defining the dots of the Braille characters, and a “female” cylinder, on the surface of which are recesses intended to receive the protrusions of the embossing cylinder. The embossing cylinder and the female cylinder are pressed against each other, with the blanks interposed therebetween.

Normally, the raised dots, or projections, which define the Braille characters are obtained on the printing/embossing cylinder with photo etching or chemical etching techniques. However, these techniques require lengthy preparation/implementation times and the use of costly equipment.

An apparatus available on the market with the trade name “ACCUBRAILLE”, manufactured by the firm BOBST, is provided with a plate element, or simple plate, which can be applied to the embossing cylinder, as an outer covering. The raised dots are produced on the plate, which is interchangeable on the relative cylinder. When it is necessary to change the writing stamped or embossed on the paper blanks, the covering plate of the embossing cylinder can be replaced with a new plate bearing the characters and writing required. The “female” cylinder remains unchanged.

In other conventional apparatus the plates provided with raised dots are constrainable to presses or equivalent devices which act on the paper media to be embossed and/or punched. The plates are pressed against the paper media, obtaining embossing of the raised dots that define the tactile or Braille characters.

In general, the metal plates are embossed manually to obtain the raised dots. This process is slow and greatly limits versatility and productivity of the apparatus for embossing paper media, such as blanks, paper/cardboard webs, films, etc., which use these plates as “die”. Manual positioning of the metal plates is mainly suited to small productions which require low productivity. However, for some time there has been a demand for automatic apparatus that perform rapid set-up of the metal plates utilized in apparatus to emboss paper media.

A further drawback of conventional solutions lies in the fact that manual embossing of the metal plates does not guarantee that all the raised dots will comply with the standard required for Braille writing. Any errors made by the operator while performing the embossing operations have a negative influence on the dimensional precision of the raised dots. In other words, the height, diameter and curvature of the raised dots can easily differ between the various dots of writing in Braille characters.

The object of the present invention is to provide a method and a relative apparatus for embossing raised dots on plate elements, in particular for embossing Braille characters on metal, plates to be used in turn to emboss paper media, which solve, in a simple and efficient manner, the drawbacks of conventional solutions, and which are also simple to implement, precise and reliable.

A further object of present invention is to provide a method and the relative apparatus for embossing raised dots on plate elements which allow large surfaces to be treated in the unit of time. In particular, the apparatus must be versatile, i.e. it must allow the writing embossed on the treated plate elements to be rapidly changed.

Yet another object of the present invention is to provide a method and the relative apparatus for embossing raised dots on plate elements which allow compliance with international standards relative to Braille writing for all the embossed dots.

### DESCRIPTION OF THE INVENTION

These and other objects are obtained by the method for embossing raised dots on plate elements according to claim 1.

In particular, the method comprises the step of moving at least one punch along a first direction, or Z axis, alternatively in the two ways of feed, to emboss a raised dot on a plate element resting on a work surface. Embossing is obtained when the punch is brought into contact against the surface of the plate element and exerts a pressure which plastically deforms this element, leaving thereon an impression corresponding to the shape of the tip of the punch.

Advantageously, the method also comprises the step of translating the plate element along a second direction, or X axis, to feed new sections of the material to be embossed to the punch. Besides moving along a first direction, the punch also moves with alternate motion along a third direction, or Y axis, orthogonal to the first direction. In other words, the punch moves along two axes, Z and Y, with alternate motion and the plate element is fed with intermittent translational motion along the X axis.

An important advantage is given by the fact that the apparatus according to the present invention allows completely automatic embossing of strip-like plate elements, and thus with a noteworthy linear extension, and not only of metal plates or sheets that according to prior art must be cut and positioned by hand.

The translational movement of the plate element is synchronized with the movement of the punch along the first (Z axis) and/or the third direction (Y axis). The punch embosses the plate element when it is stationary.

In a first case, the plate element is fed for a portion of the length thereof, and then stops, to allow the punch to emboss two raised dots along a same line of dots. In other words, two raised dots embossed by the punch which moves exclusively along the first direction, subsequent to feed of the plate element belong to a same line of dots (aligned with respect to the X axis).

In a second case, the plate element remains stationary, i.e. is not fed, to allow the punch to move along the third direction and emboss two raised dots along a same column of dots. In other words, two raised dots embossed by the punch subsequent to a movement thereof along a third direction, with the plate element stationary, belong to a same column of dots (aligned with respect to the Y axis).

The movement of the plate element is therefore synchronized with the movement of the punch, in the sense that the plate element is fed to submit new sections to the punch, and stops to allow the punch to emboss raised dots.

Those skilled in the art will understand that the reference to “lines” and “columns” of embossed dots is a convention used to distinguish the raised dots produced on the plate element along the length and along the width thereof respectively. The plate element is fed according to the second direction for portions corresponding to the distance between two subsequent raised dots along a same line. The punch moves along the third direction for a portion corresponding to the distance between two subsequent raised dots along a same column.

The punch can be operated to produce on the plate element raised dots placed in lines and columns to form tactile writing, preferably in the Braille alphabet.

The present invention also relates to an apparatus according to claim 7.

The apparatus allows raised dots to be embossed on at least partly deformable plate elements, for example metal strips with a thickness of less than 1 mm. The apparatus comprises at least one punch movable alternatively along a first direction, or Z axis, to emboss a raised dot on a plate element resting on a work surface. Advantageously, the apparatus comprises a feed device with the function of translating the plate element along a second direction, or X axis, to feed new sections of material to the punch. The punch can translate along a third direction, or Y axis, orthogonal to the first direction, to emboss at least another raised dot along a same section of the plate element.

In general, the apparatus can comprise two or more punches. Preferably, it comprises a single interchangeable punch, i.e. having a portion interchangeable according to the shape and dimensions of the raised clots to be embossed in the plate element.

According to the preferred embodiment of the present invention, the first direction, the second direction and the third direction are mutually orthogonal. Preferably, the first direction is vertical: the punch is raised and brought into contact against the surface of the plate element stationary on the work surface and emboss a raised dot on the surface thereof, without perforating the plate element. Once the raised dot has been embossed, the punch is lowered with respect to the surface of the plate element. The second direction is horizontal: the plate element moves remaining horizontal on the work surface. For example, the plate element is a metal strip and the direction of feed coincides with the linear extension thereof (longitudinal to the strip). It will be apparent to those skilled in the art that the punch moves in relation to the plate element only when the punch is stationary and the element is fed under the punch or when the plate element is stationary and the punch moves along the third direction.

The feed device is operated to transmit an intermittent movement to the plate element, as described above. For example, the feed device can be a conventional device used to feed metal strips to shearing or bending machines, etc.

Operation of the apparatus is regulated by a control unit, for example a computer. The user, through a specific interface, enters the words or codes to be embossed on the plate element in the form of tactile characters, such as Braille. The control unit processes the information entered by the user, for example to translate it into the Braille alphabet, and operates the feed device and the punch (or punches) to emboss the corresponding raised dots. Those skilled in the art will understand that the vertical travel of the punch is regulated so as to prevent perforation of the plate element.

Preferably, the control unit processes the data provided by the user on the basis of translation and/or word processing or page layout software. For example, the user can enter words, sentences, characters, symbols or codes using a normal PC keyboard, and the control unit will translate them into the Braille alphabet, or into another language that uses tactile characters, defining the number and the position of the raised dots, corresponding to the words, sentences, characters, symbols or codes entered, which must be produced on the plate element. The punch and the feed device are operated correspondingly to perform embossing of the linear element according to the diagram of raised dots processed by the control unit. The method and the apparatus according to the present invention have various advantages with respect to prior art solutions used.

The embossing speed of the raised dots is high, with evident advantages as concerns productivity. This characteristic is due to the fact that the relative movement between the punch and the plate element depends not only on the movement of the punch, but also on the feed movement of the plate element. The components of the apparatus that support and move the punch can therefore be designed to maximize the operating speed of the punch along only two directions, i.e. along the Z and Y axes. In other words, with regard to the embossing speed and the production costs of the apparatus, it was more convenient so that the plate element is fed along the second direction rather than moving the punch along three axes/directions.

The apparatus according to the present invention is simple to use. The user interface of the control unit allows the information to be entered through a simple keyboard. The sentences, single words or alphanumeric codes can be processed by the control unit as normally occurs using a computer and word processing programs. In other words, the user can use the apparatus according to the present invention as is it were a printer of tactile characters on metal plate media.

The translation software that can be installed in the control unit allows the user to specify words, sentences and alphanumeric codes in his or her own language, leaving the apparatus the task of defining the number and position of the corresponding dots to be embossed on the plate element.

The plate elements embossed using the apparatus according to the present invention can in turn be used to emboss paper media, for example as dies to emboss Braille characters on paper media to be used to produce packaging for medicinal or other products.

The apparatus and the method according to the present invention allow raised dots to be embossed with high repeatability with regard to the dimensions and the shape of these dots. In other words, the raised dots embossed on the plate elements have negligible variations in dimension and shape with regard to compliance with international standards on writing with Braille or tactile characters.

### BRIEF DESCRIPTION OF THE DRAWINGS

The present invention will now be described in detail with reference to the drawings attached by way of a non-limiting example, wherein:

FIG. 1 is a side view of an apparatus according to the present invention;

FIG. 2 is a perspective view of a detail of the apparatus shown in FIG. 1;

FIG. 3 is an enlarged perspective view of a detail of the apparatus shown in FIG. 1;

FIG. 4 is a perspective view of a detail of the apparatus shown in FIG. 1;

FIG. 5 is a perspective top view of a detail of the apparatus shown in FIG. 1;

FIG. 6 is a perspective top view of a detail of the apparatus shown in FIG. 1;

FIG. 7 is a perspective view of an element machined according to the method of the present invention;

FIG. 8 is a cross sectional view of the machined element shown in FIG. 7.

### DETAILED DESCRIPTION OF THE INVENTION

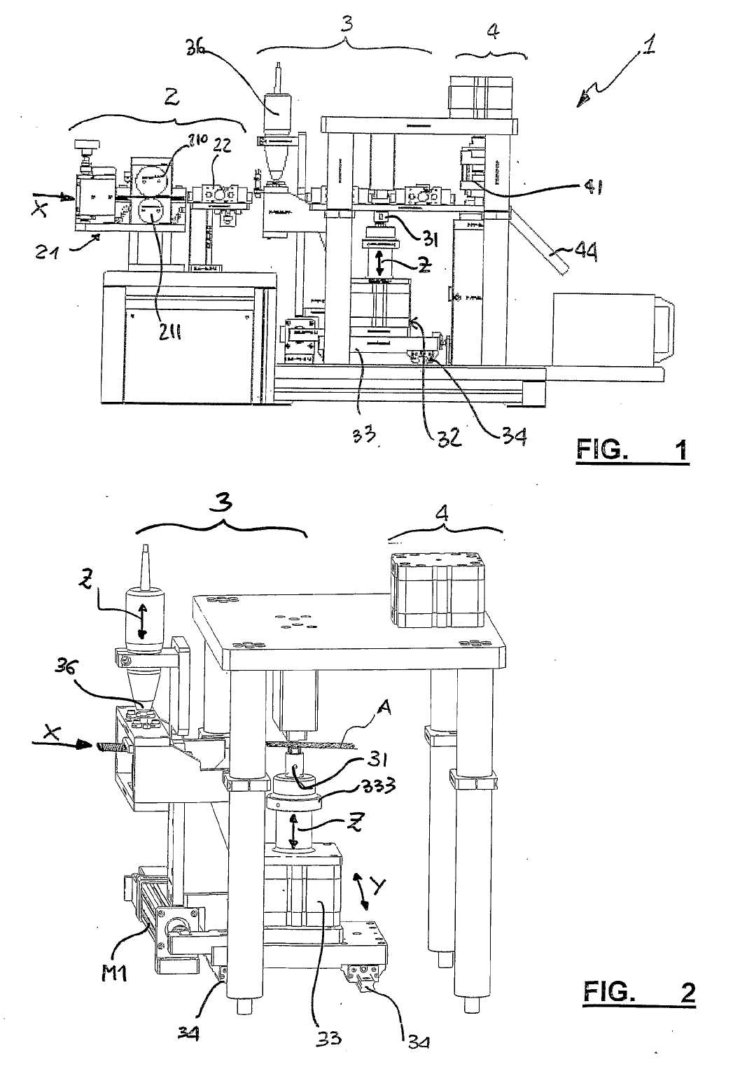

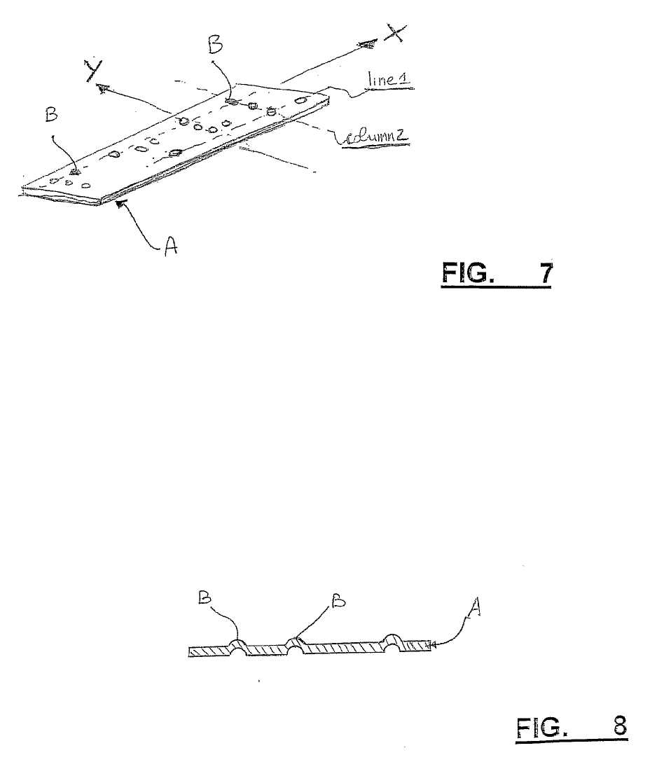

With reference to FIG. 1, these is shown an apparatus 1 according to the present invention for embossing raised dots on plate elements in particular elements at least partly plastically deformable, according to a pre-established configuration. An embossed metal plate A (FIGS. 7 and 8), obtainable by means of the apparatus 1 and the method according to the present invention is provided with a plurality of dots B raised with respect to the upper surface thereof. The raised dots B are placed according to the configuration established by the Braille alphabet, but in general can be placed to form writing, characters and alphanumeric codes of any type, readable by touch by the blind. In general, the apparatus 1 comprises a feed device 2 of a plate element A to be embossed (FIG. 7), a punching device 3 and an unloading section 4 of the, embossed, plate element.

In general, the feed device 2 can be of the conventional type, for example of the type used in machines for bending plates for dies.

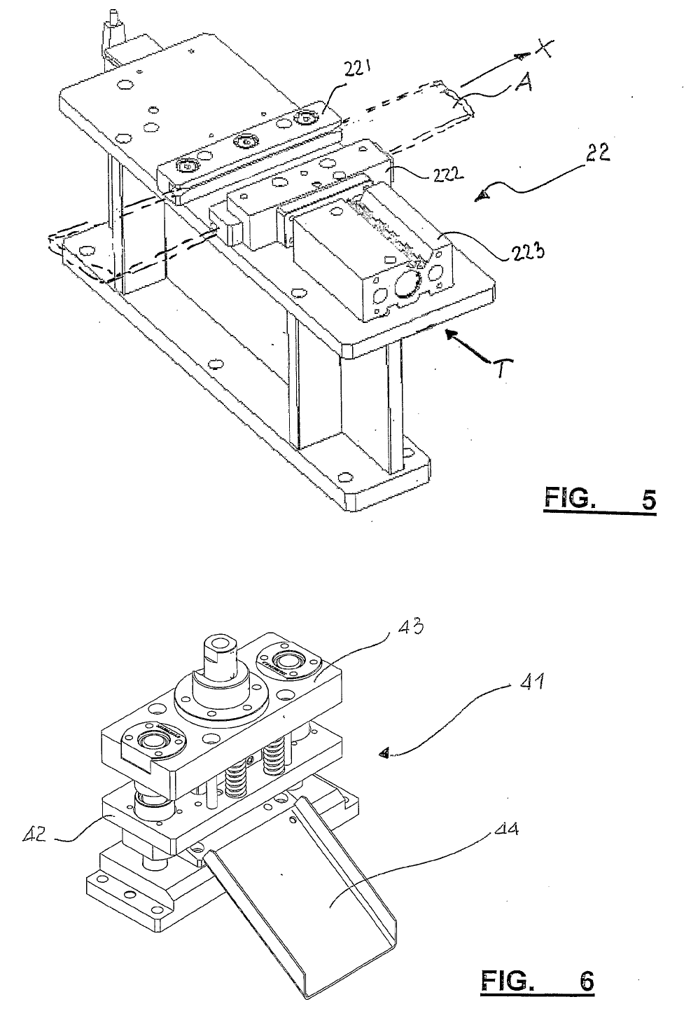

FIGS. 5 and 6 show perspective views and details of two components of a preferred embodiment of the feed device 2, which comprises a motorized feed system 21 and an alignment system 22. The feed system 21 shown in the figures comprises at least a first driving wheel 210 positioned opposite a second wheel 211 which can also be driving, or alternatively driven. The plate element A, for example a metal strip with a thickness of less than 1 mm, is clamped between the wheels 210 and 211 which rotate in the direction indicated by the arrows in FIG. 4. The distance between centres of the wheels 210 and 211 can be regulated to adapt the feed device 2 to the thickness of the plate element A to be fed to the punching device 3. At least one motor M operates the driving wheel 210. Alternatively, as shown in FIG. 4, two motors M each operate one wheel 210, 211. The motors M are controlled by the control unit of the apparatus 1 to transmit a feed movement to the metal strip A along a direction X, synchronized with the movement of the punching device 3.

The alignment system 22, shown in FIG. 5, comprises two lateral guides 221 and 222 on which the lateral edges of the metal strip A to be embossed slide. The guide 221 is fixed with respect to the feed system 21, while the guide 22 is movable along the direction T to adapt the distance between the centres of the guides 221, 222 to the width of the strip A being machined. The guide 222 is constrained to a regulator 223 which can be manual, for example with screw control, or be motorized, controlled by the control unit of the apparatus 1. The regulator 223 can be operated to move the guide 222 towards and away from the fixed guide 221, so as to bring both the guides 221, 222 into contact against the lateral sides of the strip A and align the strip A with respect to the embossing device 3 positioned downstream with respect to the direction of feed X.

Preferably, the regulator 223 is controlled by the control unit of the apparatus to adapt automatically to the width of the strip A fed to the apparatus 1.

In the embodiment shown in the attached figures, the alignment system 22 positioned downstream of the feed system 21 with respect to the direction X of feed of the strip A. Alternatively, the alignment system 22 can also be positioned upstream of the feed system 21. What, is important is that the strip A is not subject to unwanted movements in the transverse direction T.

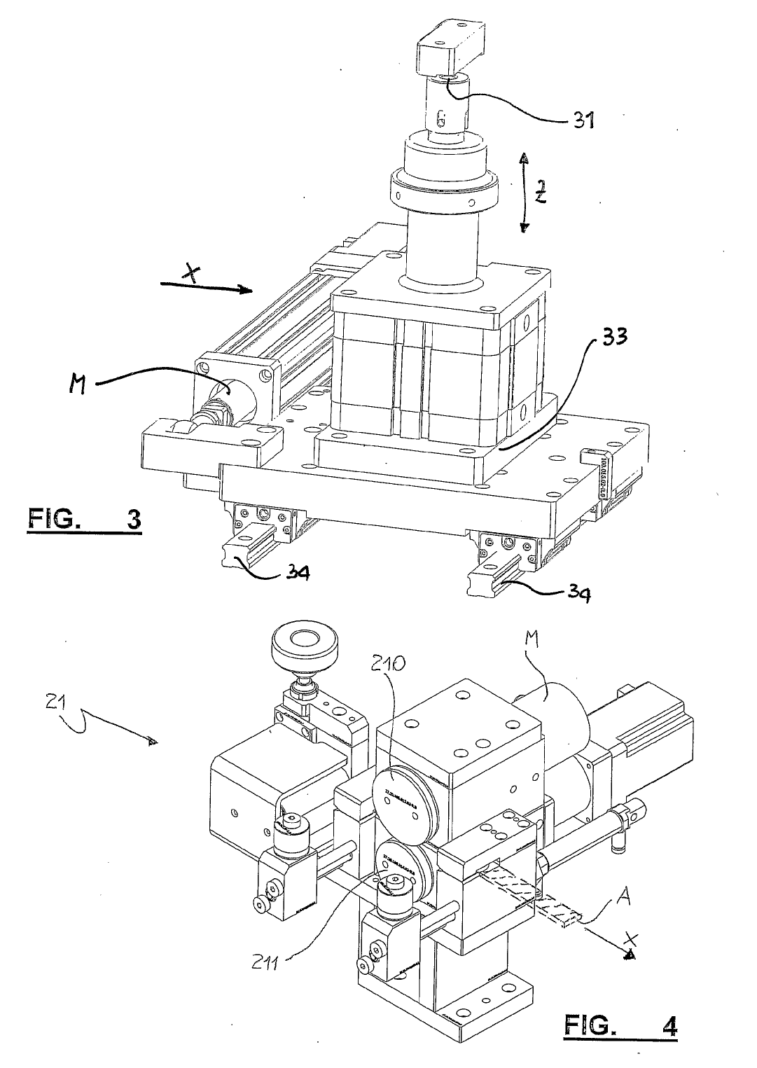

FIGS. 1-3 show in particular the preferred embodiment of the punching device 3. This device comprises at least one punch 31, movable alternatively along a first incident direction Z with respect to the feed plane of the strip element A. The punch 31 is operated by the control unit of the apparatus 1 to be brought into contact against the plate element A and emboss a raised dot B on the surface thereof. Once embossing has been preformed, the punch 31 is returned to its initial lowered position thereof, disengaging the plate element A and allowing it to advance in the direction X.

Preferably as shown in FIGS. 1-3, the punch can move alternatively along a first direction Z, or Z axis, vertical with respect to the direction X of feed of the metal strip A.

The forward travel of the punch 31, i.e., the vertical upward movement, is sufficient obtain embossing of the metal strip A with a raised dot having a pre-established height with respect to the surface of the strip A. The return stroke of the punch 31, i.e. the vertical downward movement, is sufficient to disengage the metal strip A and allow it to advance in the direction X.

Preferably, the tip of the punch 31 is interchangeable to emboss in the plate element A raised dots with different geometrical characteristics, for example, with regard to maximum diameter, curvature of the top, height, etc . In other words, the punch 31 can be provided with a tip suitable to emboss raised dots with geometrical characteristics corresponding to the international standards for Braille writing, or with a tip suitable to emboss dots with geometrical characteristics complying with other standards.

The feed movement of the plate element A is intermittent and synchronized with the vertical movement of the punch 31. After the punch 31 has embossed a raised dot B on the plate element A and has moved to a disengaged position, the plate element A is moved for a portion equal to the distance between two consecutive raised dots B along the direction X (FIG. 7) and stops. The feed movement of the plate element A is obtained by operating the motor or motors M of the feed system 21. An encoder, or other equivalent device connected to the control unit allows a feedback control to be performed on the length of the portion travelled by the element A. When the plate element A stops, the punch 31 is raised to emboss a new raised dot B.

With reference to FIG. 7, two raised dots B along the same feeding direction X belong to a same line of dots. In FIG. 7 the first line of dots B is indicated wit the wording “line 1”.

As shown in FIG. 1-3, the apparatus 1 preferably also comprises a vertical regulator 333, controlled by the control unit, which regulates the distance of the stationary punch with respect to the horizontal guides 34. This regulator allows the initial position of the punch 31 to be adapted to the thickness of the plate element A being machined.

Advantageously, the punching device 3 also comprises a device 32 for moving the punch 31 along a second direction Y transverse both to the direction of feed X, and to the direction of embossing Z. Alternatively, if there are two hunches, the movement device 32 can operate only one or both of the punches 31.

The device 32 generally comprises a carriage 33 which supports the punch 31 and which can translate along horizontal guides (in practice, two rails) 34 oriented along the direction Y. The travel of the carriage 33 in both directions is such as allow the punch 31 to emboss raised dots B on the entire width of the metal strip A.

Operation of the apparatus 1 is simple. The feed device 2 feeds new sections of plate element A to the punching device 3, while the movement device 32 moves the punch 31 transversely to emboss raised dots along a same section of the element A, i.e., in practice in the direction of the width thereof. The control unit coordinates operation of the punch or punches 31, along the directions Y and Z, in practice along the two Y and Z axes.

With reference to FIG. 7, two raised dots B aligned with respect to the transverse direction Y of movement of the carriage 33, belong to a same column of dots B. In FIG. 7, the first column of dots B is indicated with the wording “column 2”.

The control unit controls feed device 21 and the carriage 33 supporting the punch 31, so as to intercept any dot of the upper surface of the strip A. When the strip A is stationary, the unit controls upward movement of the punch 31 which comes into contact with the strip A and deforms it locally to emboss a raised dot B.

Downstream of the punching device 3, in the unloading section of the device 1, there is preferably provided a shearing machine 41 with the function of separating a portion of strip A from the remaining portion. The shearing machine shown in detail in FIG. 6 comprises a blade 42 thrust vertically by a presser 43. The portion of sheared strip A is ejected from the apparatus through a chute 44. The shearing machine 41 and the chute 44 are not shown in FIG. 2.

The control unit coordinates the movement of the feed system 2, i.e. the movement of the wheels 210, 211 of the feed device 21 that push the strip A along the X axis, the vertical movement along the Z axis of the punch 31 and the transverse movement along the Y axis of the carriage 33 that supports the punch 31. In practice, the punch 31 can move along two axes (Y axis, Z axis) while the strip A can translate along a different axis (X axis).

The control unit controls the various devices and systems of the apparatus 1 on the basis of algorithms stored in a specific memory. Preferably, the control unit operates on the basis of information supplied by the uses through a specific interface. Preferably, the control unit is electronic, such as a PC or processor which has been loaded with specific software to manage the apparatus 1 and to interface with the user.

The user enters the information to be embossed on the metal strip A in the control unit. The interface can for example, comprise a keyboard and a monitor. The control unit processes the information entered by the user and operates the apparatus 1 to obtain embossing of the strip A corresponding to the information entered or processed. In practice, the management software of the apparatus 1 allows the control unit to calculate the movements of the strip A and of the punch 31 corresponding to the die of the raised dots to be embossed on the strip A.

Preferably, the control unit is provided with word processing and/or automatic translation software. The user enters the information using the specific interface and, using the word processing software, can choose and modify the page layout of the raised dots to be embossed on the strip A, i.e. the position of these dots on the strip A. The automatic translation software allows the information entered by the user using conventional alphanumeric characters, for example in his or her language, be translated into the Braille alphabet, or into other tactile alphabets.

For example, the control unit processes the characters, words, sentences or alphanumeric codes provided by the user and, on the basis of this processing proposes one or more possible alternatives for translation of this information into Braille and the relative page layout on the metal strip A. i.e. proposes possible positionings of the Braille characters on the strip according to the number of lines and columns desired by the user or available according to the dimensions of the strip A.

The apparatus and the method according the present invention allow embossing of at least partly yielding plate elements, in particular metal plates with high speed and great versatility. The control unit coordinates and controls the relative movement between the punch 31 and the plate A to obtain the maximum number of raised dots B in the unit of time, with equal dimensions and consequently maximizing productivity. The punch is operated along the Y and Z axes, while the strip A is fed along the X axis. This configuration has proved efficient in terms of rapid embossing.

The apparatus according to the present invention is simple to use. The user enters the information using a simple interface. The control unit processes it and operates the punch 31, the carriage 33 and the feed system 2 to emboss the raised dots B corresponding to the processed information.

The translation software installed in the control unit allows the user to specify words, sentences and alphanumeric codes in his or her own language, leaving the apparatus 1 the task of proposing a possible page layout of the corresponding dots B to be embossed on the plate element A.

The plate elements A embossed by the apparatus 1 can be used in turn to emboss paper media. Preferably, the plate elements A are metal plates, made for example of aluminium.

The interchangeability of the tip of the punch 31 allows the shape and the dimension, of the dots B embossed to be varied and the apparatus 1 to be adapted to the material of the plate element A or to the type of dots to be embossed with evident advantages in relation to the versatility of the apparatus 1.

The apparatus 1 allows raised dots B identical to one another to be embossed.

As shown in FIGS. 1 and 2, the apparatus 1 preferably also comprises a tool 36, for example a milling cutter, with the function of cutting marks on the plate element A. The tool 36, which is controlled by the control unit, can be positioned upstream or downstream of the punch 31 with respect to the direction of feed of the strip A. In the embodiment shown in the figures, the milling cutter 36 is positioned between the feed device 2 and the punch 31. The milling cutter 36 is brought into contact with the surface of the strip element A to engrave, for example, letters, numbers of characters in a different alphabet the Braille, illustrative of what has instead been written in Braille by the punch 31. The tip of the milling cutter 36 is also movable along the Z axis to engage/disengage the surface of the strip A.

1. A method for embossing raised dots (B) on plate elements (A), comprising the step of moving at least one punch (31) along a first direction (Z), alternatively in the two ways of feed, to emboss a raised dot (B) on a plate element (A) which rests on a work surface intersected by said first direction (Z), characterized by the step of translating said plate element (A) along a second direction (X) to feed new sections of said plate element (A) to the punch (31), and by the step of translating said at least one punch (31) along a third direction (Y), orthogonal to said first direction (Z), to emboss at least another raised dot (B) along a same section of the plate element (A).

2. The method as claimed in claim 1, wherein the translational movement of said plate element (A) is synchronized with the movement of said at least one punch along said first direction (Z) and/or along said third direction (Y).

3. The method as claimed in claim 2, wherein said plate element (A) is stationary when said at least one punch is engaged with the surface thereof to perform embossing of a raised dot (B).

4. The method as claimed in claim 1, wherein said plate element is fed along said second direction (X) for a portion corresponding to the distance between two subsequent raised dots along a same line.

5. The method as claimed in claim 1, wherein said at least one punch moves along said third direction (Y) for a portion corresponding to the distance between two subsequent raised dots (B) along a same column.

6. The method as claimed in claim 5, wherein the raised dots are placed in lines and columns to form tactile writing on said plate element.

7. The method as claimed in claim 1, characterized in that it also comprises a step of acquiring information provided by the user and containing one or more characters/symbols, a step of processing said information by means of translation and/or word processing software and a step of operating said at least one punch (31) and/or control said feed on the basis of said processing to emboss raised dots (B) corresponding to said characters/symbols.

8. An apparatus (1) to emboss raised dots (B) on at least partly deformable plate elements (A), comprising at least one punch (31) movable alternatively along a first direction (Z) to emboss a raised dot (B) on a plate element (A) which rests on a work surface intercepted by said first direction (Z), characterized in that it also comprises a feed device (2) of said plate element (A) along a second direction (X), which can be operated to feed new sections of said plate element (A) to the punch (31), and in that said at least one punch (31) can be translated along a third direction (Y), orthogonal to said first direction (Z), to emboss at least another raised dot (B) along a same section of the plate element (A).

9. The apparatus as claimed in claim 8, wherein said first direction (Z), said second direction (X) and said third direction (Y) are mutually orthogonal.

10. The apparatus as claimed in claim 8, wherein said translation movement of said plate element is intermittent and synchronized with the movement of said at least one punch (31) to emboss raised dots (B) on said stationary plate element (A).

11. The apparatus as claimed in claim 8, wherein said first direction (Z) is vertical with respect to said work surface and said second direction (X) and said third direction (Y) are horizontal with respect to said work surface.

12. The apparatus as claimed in claim 8, wherein the movement of said at least one punch (31) along said third direction (Y) is alternative.

13. The apparatus as claimed in claim 8, wherein said at least one punch (31) is interchangeable.

14. The apparatus as claimed in claim 8, characterized in that it also comprises a unit that controls the feed device and movement of said at least one punch (31) on the basis of processing information provided by the user through an interface of the control unit.

15. The apparatus as claimed in any claim 14, wherein said control unit processes the information by means of a translation and/or word processing program.

16. A method of use of the apparatus according to claim 8, comprising embossing tactile characters on metal plates (A) to treat paper media.
